(19) United States
(12) Patent Application Publication
(10) Pub. No.: US 2026/0249862 A1
(43) Pub. Date: Aug. 27, 2026

(54) METHOD FOR TRAINING A CONTROL DEVICE FOR A ROBOTIC APPARATUS

(71) Applicant: Robert Bosch GmbH, Stuttgart (DE)

(72) Inventors: Sebastian Ziesche, Leonberg (DE); Benjamin Coors, Stuttgart (DE); Johannes Goth, Wildberg (DE); Matthias Bitzer, Stuttgart (DE); Maximilian Naumann, Mountain View, CA (US); Philipp Geiger, Karlsruhe (DE); Reinis Cimurs, Stuttgart (DE)

(21) Appl. No.: 19/547,872

(22) Filed: Feb. 24, 2026

(30) Foreign Application Priority Data
Feb. 27, 2025 (DE) 10 2025 107 485.2

(51) Int. Cl. B60W 50/00; G05B 13/02

(52) U.S. Cl. CPC B60W 50/0098; G05B 13/027; B60W 2050/0022

(57) ABSTRACT

A method for training a control device for a robotic apparatus. The method includes: ascertaining a training dataset with a set of training trajectories; ascertaining an imitation loss between the training trajectories and trajectories supplied by the control device, wherein the imitation loss for each training trajectory has a single loss to a particular trajectory supplied by the control device; wherein a weighting factor for the single loss is ascertained depending on the trajectory supplied by the control device and the single loss is weighted in the imitation loss by the weighting factor, wherein the weighting factor is piecewise constant with respect to the trainable parameters of the control model, and training the control device to reduce the imitation loss.

### FIELD

The present disclosure relates to methods for training a control device for a robotic apparatus.

### BACKGROUND INFORMATION

When controlling a robotic apparatus in a control situation, there are risks of undesired events occurring, in particular accidents, such as with other road users when an at least partially automated vehicle is being controlled in road traffic or when there is a human user who is near a robotic arm that is being controlled. It is desirable for control devices for robotic apparatuses to be trained in such a way that the risk of such undesired events occurring during control is minimized.

### SUMMARY

According to the various example embodiments, a method for training a control device for a robotic apparatus is provided, comprising ascertaining a training dataset with a set of training trajectories, ascertaining an imitation loss between the training trajectories and trajectories supplied by the control device, wherein the imitation loss for each training trajectory has an individual loss relative to a particular trajectory supplied by the control device, wherein a weighting factor for the individual loss is ascertained depending on the trajectory supplied by the control device and the individual loss is weighted in the imitation loss by the weighting factor, wherein the weighting factor is piecewise constant with respect to the trainable parameters of the control model, and training the control device to reduce the imitation loss.

The method described above makes possible a training of a control device with a focus on avoiding undesirable events. If a weighting factor is set so that it has a first value when an event occurs and a second value when the event does not occur, the gradient of the weighting factor no longer provides any information about the direction in which the parameters of the control device are to be adjusted, since the gradient is either undefined or equal to zero at every point. Such piecewise constant functions are usually not part of a loss function, precisely because their gradient carries no information.

Various exemplary embodiments are specified below.

Exemplary embodiment 1 is a method for training a control device for a robotic apparatus as described above.

Exemplary embodiment 2 is a method according to exemplary embodiment 1, comprising, for each training trajectory, assigning the trajectory supplied by the control device to a category of a specified set of categories (e.g., “collision occurring” “collision not occurring,” “vehicle driving off-road,” “vehicle not driving off-road,” and combinations thereof), wherein a particular weighting factor is assigned to each category of the specified set of categories (e.g., collision->weighting factor high, no collision->weighting factor low (e.g., one)) and weighting the individual loss in the imitation loss with the weighting factor assigned to the category to which the trajectory supplied by the control device has been assigned.

This allows the focus of training to be placed on avoiding undesirable events such as collisions, leaving the road and getting into oncoming traffic. For example, the weighting factor is 1 if none of these events occur and higher (e.g., five or ten) if one or even a plurality of these events occur (according to the predicted trajectory in the particular example scenario). When combining categories, weighting factors can also be combined, e.g. not only collision but also off-road->the weighting factor is chosen, for example, as the maximum or sum of the weighting factors assigned to these categories.

Exemplary embodiment 3 is a method of exemplary embodiment 1 or 2, wherein the robotic apparatus is a vehicle, wherein each training trajectory is a vehicle trajectory in a particular traffic situation.

Exemplary embodiment 4 is a data processing system configured to carry out a method according to one of exemplary embodiments 1 to 3.

Exemplary embodiment 5 is a computer program comprising commands that, when executed by a processor, cause the processor to perform a method according to one of exemplary embodiments 1 to 3.

Exemplary embodiment 6 is a computer-readable medium that stores commands that, when executed by a processor, cause the processor to perform a method according to one of exemplary embodiments 1 to 3.

In the figures, similar reference signs generally refer to the same parts throughout the various views. The figures are not necessarily true to scale, with emphasis instead generally being placed on the representation of the principles of the present disclosure. In the following description, various aspects are described with reference to the figures.

### BRIEF DESCRIPTION OF THE DRAWINGS

FIG. 1 shows a vehicle according to an example embodiment.

FIG. 2 shows a flowchart illustrating a method for training a control device for a robotic apparatus according to one example embodiment.

### DETAILED DESCRIPTION OF EXAMPLE EMBODIMENTS

The following detailed description relates to the figures, which show, by way of explanation, specific details and aspects of this disclosure can be executed. Other aspects may be used, and structural, logical, and electrical changes may be carried out without departing from the scope of protection of the present disclosure. The various aspects of this disclosure are not necessarily mutually exclusive, since some aspects of this disclosure may be combined with one or more other aspects of this disclosure to form new aspects.

Various examples are described in more detail below.

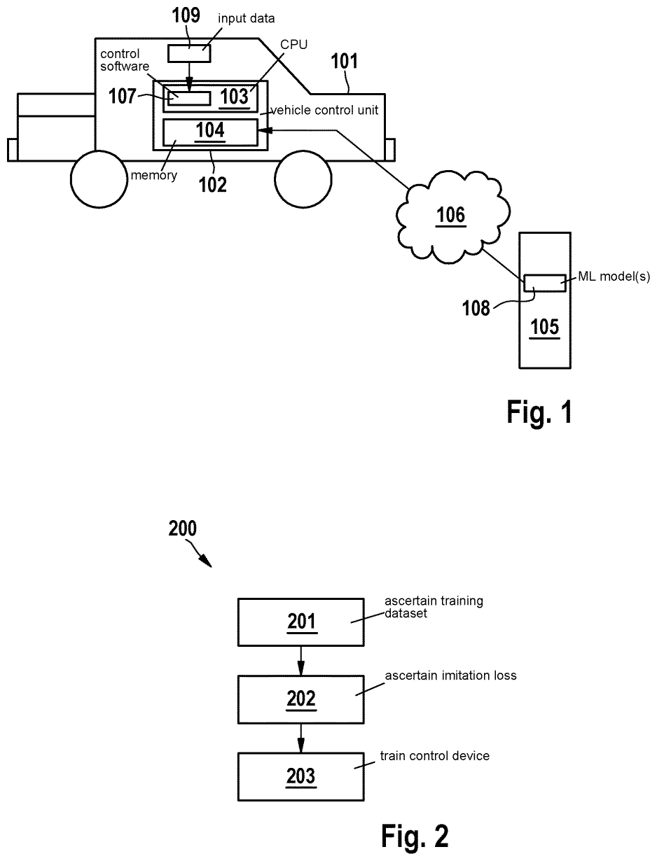

FIG. 1 shows a vehicle 101.

In the example of FIG. 1, a vehicle 101, for example a motor vehicle such as a passenger car or truck, is provided with a vehicle control unit (for example, an electronic control unit (ECU)) 102.

The vehicle control unit 102 comprises data processing components, for example a processor (for example, a CPU (central processing unit)) 103 and a memory 104 for storing control software 107 according to which the vehicle control unit 102 operates, and data that are processed by the processor 103. The processor 103 executes the control software 107.

For example, the stored control software (computer program) comprises instructions that, when executed by the processor, cause the processor 103 to execute driver assistance functions or even to control the vehicle autonomously.

The control software 107 is, for example, transmitted to the vehicle 101 from a computer system 105, for example via a network 106 (or by means of a storage medium such as a memory card). This can also take place in operation (or at least when the vehicle 101 is with the user) since the control software 107 is updated over time to new versions, for example.

The control software 107 can, for example, be trained using machine learning (ML), i.e. the control software 107 implements one or more ML models 108 (or machine learning model), which is trained based on training data, in this example by the computer system 105. The computer system 105 thus implements an ML training algorithm for training the one or more ML models 108 which are used to control the vehicle 101.

According to various embodiments, the vehicle 101 is at least partially automated. In autonomous driving and related fields, the objective is typically to train a control policy for a driving agent, i.e. an ML model 108 (or a control device 102 that implements an ML model 108) is to be trained in such a way that, on the basis of input data, it specifies a control action that is to be carried out. In other words, the control software 107 performs one or more driving functions (e.g. fully autonomous driving) by ascertaining control actions for the vehicle (such as steering actions, braking actions, etc.) from input data 109 available to it, which contain information about the environment of the vehicle 101, by means of one or more ML models 108 to which the input data are supplied, and controls components of the vehicle correspondingly. The input data 109 are, for example, sensor data such as information obtained from a camera of the vehicle or via communication with other vehicles or external apparatuses on the roadside, or data derived therefrom (e.g. by object detection).

Since an ML model 108, which specifies one or more control actions for a vehicle 101, determines the path that the vehicle 101 takes, the ML model 108 specifies (at least over a plurality time steps but possibly also at once) a trajectory, i.e. a sequence of positions (or poses, e.g. when applied to a robot arm) over time. It can therefore be trained using training trajectories, i.e. trajectories that are to be used in example scenarios (with associated training input data).

Accordingly, for training such an ML model, a training loss is typically calculated, inter alia, on the basis of the distance (i.e. the difference) between a training trajectory and a trajectory supplied (i.e. generated or predicted) by the ML model, and the ML model is adapted to reduce a loss that contains such training loss for many (typically a batch of) example scenarios (e.g. weights of a neural network are adapted by means of backpropagation). As a rule, for each trajectory that contributes to the training loss, the training loss supplied by it (herein also referred to as individual loss in order to distinguish it from the “total” training loss which contains individual losses for multiple (e.g. a batch of) training trajectories) is weighted equally.

Expressed more formally, during training (e.g. in a training iteration), a loss Σ_{t∈D}l(t, p_{θ}(t₀)) is ascertained, where
D is a dataset (e.g., a batch) of training trajectories (in other words: ground-truth trajectories), wherein each training trajectory t belongs to an example scenario, in particular initial conditions to (e.g. including input data)
l is a loss function that measures the deviation of the generated (i.e. predicted) trajectory and the ground-truth trajectory from the dataset. For each training trajectory this is thus an imitation loss between the predicted trajectory and the training trajectory (i.e. ground-truth trajectory)
p_{θ} is the mapping effected by the ML model (from the input data to one or more control actions), which depends on the trainable parameters θ of the ML model (i.e. the parametrized control policy to be trained) and which delivers the predicted trajectory for the particular example scenario.

The parameters θ are modified in each training iteration so that the loss Σ_{t∈D}l(t, p_{θ}(t_{θ})) is reduced (e.g. by backpropagation of the loss through a neural network, in the case in which the ML model is a neural network).

According to various embodiments, it is provided to weight the loss contribution l(t, p_{θ}(t₀)) (i.e. individual loss) of each training trajectory (for at least some of the training trajectories) with a weighting factor (i.e., for example, to multiply it), which is based on certain important features (which may even be piecewise constant with respect to the trainable parameters), such as, e.g., “does the trajectory generated for the particular example scenario collide with another vehicle,” “does the trajectory generated for the particular example scenario remain on the road.”
In this way, during training an incentive is created that the ML model focuses more strongly on training trajectories that are weighted more strongly by such weighting factors and predicts these as precisely as possible. The weighting factors may thus be used for fine-tuning the ML model to specific details.

Instead of the (standard) training loss Σ_{t∈D}l(t, p_{θ}(t_{θ})) specified above, a loss with weightings Σ_{t∈D}ƒ(t, p_{θ}(t₀))l(t, p_{θ}(t₀)) is therefore used, where ƒ is a weighting function, i.e. delivers a weighting factor that depends on the training trajectory and/or the predicted trajectory. According to various embodiments, ƒ is piecewise constant with respect to the trainable parameters θ. When using such a loss with weightings, the ML model is trained in such a way that it primarily correctly calculates the training trajectories with a higher weighting factor (i.e. predicts a trajectory for which the particular individual loss is as small as possible). For example, through such training and a corresponding weighting factor, a predicted trajectory that causes a collision (or another undesired event, e.g. the vehicle leaves the road (off-road)) could be drawn more strongly toward the ground truth in which no collision occurs, e.g. by the function ƒ being defined in such a way that it assumes a high value (e.g. five or ten) for predicted trajectories that cause a collision. In this way, the collision rate in the generated trajectories (relative to training in which the standard training loss is used) could be reduced (with the same number of training trajectories and training iterations).

Due to an appropriate selection of the weighting factors (i.e. of the function ƒ), the training loss can thus in particular be aligned with piecewise constant features, and the training can be focused on specific features. In particular, undesired behavior of the (trained) ML model that occurs only rarely (and therefore contributes little to the standard loss) can be further reduced. For example, a reasonably well-trained control policy could lead to a collision in only one in a hundred cases. However, a lower accident risk is typically desirable and accordingly it could be desirable to train a policy that leads to a collision only in one in a million cases. In order to achieve this, by means of the above-described approach of using weighting factors during training, a particular focus can be placed on collisions (i.e. predicted trajectories that lead to collisions in the respective example scenarios). In contrast to adding auxiliary losses, such as a collision loss, the above-described training loss with weightings still aims exclusively at imitation and does not introduce loss components that lead to the ML model learning behaviors that are not represented by the training data.

For example, the following procedure is used:
select a preferred architecture for a neural network for representing a driving strategy (i.e. control strategy for a vehicle)
select the preferred dataset, the training procedure, and the loss l
define features to which particular attention is to be given and define a corresponding function ƒ
perform the training with ƒl as an individual loss instead of l

It should be noted that a vehicle is merely one example, and a similar approach may also be used for other robotic apparatuses, since for example it is typically also important for robot arms that collisions with workpieces, human users, etc., are avoided.

In summary, according to various embodiments, a method is provided as shown in FIG. 2.

FIG. 2 shows a flowchart 200 that represents a method for training a control device for a robotic apparatus according to an embodiment. Training is to be understood as adapting trainable parameters of the control device (such as, for example, weights of a neural network).

In 201, a training dataset with a set of training trajectories is ascertained. This can also comprise simulations, use of real traffic situations, and also merely the selection from an existing training dataset (e.g. from a database). The training dataset here can also just be a batch from a larger training dataset that is used in successive training iterations.

In 202, an imitation loss between the training trajectories and trajectories supplied by the control device is ascertained. For example, for each training trajectory (that the training dataset contains for a particular example scenario), a trajectory is ascertained by means of the control device.

The imitation loss has, for each training trajectory, an individual loss relative to a particular trajectory supplied by the control device (i.e. each training trajectory belongs to an example scenario and the control device delivers a particular (predicted) trajectory for the example scenario), wherein a weighting factor for the individual loss is ascertained depending on the trajectory supplied by the control device and the individual loss in the imitation loss is weighted with the weighting factor, wherein the weighting factor is piecewise constant with respect to trainable parameters of the control model (i.e. at least a part of the parameters of the control model that can be adapted during training, such as, for example, the weights of a neural network).

In 203, the control device is trained to reduce the imitation loss.

A supplied trajectory can be a real journey or a simulated trajectory. It is generated by the control device, for example, in such a way that the control device initially receives a start state of the particular training trajectory (i.e. of the particular example scenario), all other traffic participants are played back as in the example scenario (in time steps), and the control device then receives corresponding input data (e.g. observations) for each time step, and step-by-step (taking into account the input data supplied to it at the particular time step) generates the trajectory by generating a state for each time step.

The method in FIG. 2 cam be performed by one or more computers with one or more data processing units. The term “data processing unit” may be understood as any type of entity that allows for processing of data or signals. The data or signals can be processed, for example, according to at least one (i.e., one or more than one) specific function which is carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail herein may also be understood as a data processing unit or logic circuit assembly. One or more of the method steps described in detail here can be carried out (e.g., implemented) by a data processing unit by one or more specific functions that are carried out by the data processing unit.

The method is therefore in particular computer-implemented according to various embodiments.

The approach in FIG. 2 serves for training a machine learning model that serves for generating a control signal for a robotic apparatus. The term “robotic apparatus” may be understood to mean any technical system (comprising a mechanical part of which the movement is controlled), such as a computer-controlled machine, a vehicle, a robotic arm, a household appliance, a power tool, a manufacturing machine, a personal assistant, or an access control system.

Various embodiments can receive and use sensor signals from various sensors such as, for example, video, radar, lidar, ultrasound, motion, thermal imaging, etc., for example in order to detect a particular control situation (i.e. scenario) (and, for example, generate input data for the machine learning model). The sensor data can be used directly as input for the machine learning model or may be at least partially processed (e.g. by an upstream machine learning model). This process can comprise the classification of the sensor data or the performance of a semantic segmentation of the sensor data, for example in order to detect the presence of objects (in the environment in which the sensor data were obtained).

1-6. (canceled)

7. A method for training a control device for a robotic apparatus, comprising the following steps:
ascertaining a training dataset with a set of training trajectories;
ascertaining an imitation loss between the training trajectories and trajectories supplied by the control device, wherein the imitation loss has, for each training trajectory of the training trajectories, an individual loss relative to a respective trajectory supplied by the control device, wherein a weighting factor for the individual loss is ascertained depending on the respective trajectory supplied by the control device, and the individual loss in the imitation loss is weighted with the weighting factor, wherein the weighting factor is piecewise constant with respect to trainable parameters of the control device; and
training the control device to reduce the imitation loss.

8. The method according to claim 7, further comprising, for each training trajectory of the training trajectories, assigning the respective trajectory supplied by the control device to a category of a specified set of categories, wherein each category of the specified set of categories is assigned a respective weighting factor, and weighting the individual loss in the imitation loss with the respective weighting factor that is assigned to the category to which the respective trajectory supplied by the control device was assigned.

9. The method according to claim 7, wherein the robotic apparatus is a vehicle, wherein each training trajectory of the training trajectories is a vehicle trajectory in a particular traffic situation.

10. A data processing system configured to perform a method for training a control device for a robotic apparatus by performing the following steps comprising:
ascertaining a training dataset with a set of training trajectories;
ascertaining an imitation loss between the training trajectories and trajectories supplied by the control device, wherein the imitation loss has, for each training trajectory of the training trajectories, an individual loss relative to a respective trajectory supplied by the control device, wherein a weighting factor for the individual loss is ascertained depending on the respective trajectory supplied by the control device, and the individual loss in the imitation loss is weighted with the weighting factor, wherein the weighting factor is piecewise constant with respect to trainable parameters of the control device; and
training the control device to reduce the imitation loss.

11. A non-transitory computer-readable medium on which is stored commands for training a control device for a robotic apparatus, the commands, when executed by a processor, causing the processor to perform the following steps comprising:
ascertaining a training dataset with a set of training trajectories;
ascertaining an imitation loss between the training trajectories and trajectories supplied by the control device, wherein the imitation loss has, for each training trajectory of the training trajectories, an individual loss relative to a respective trajectory supplied by the control device, wherein a weighting factor for the individual loss is ascertained depending on the respective trajectory supplied by the control device, and the individual loss in the imitation loss is weighted with the weighting factor, wherein the weighting factor is piecewise constant with respect to trainable parameters of the control device; and
training the control device to reduce the imitation loss.
